(19) United States
(12) Patent Application Publication
(10) Pub. No.: US 2012/0273636 A1
(43) Pub. Date: Nov. 1, 2012

(54) HANGER HOLDER ACCESSORY AND SYSTEM

(76) Inventor: MARTHA MCKENZIE, Eufaula, AL (US)

(21) Appl. No.: 13/095,399

(22) Filed: Apr. 27, 2011

(51) Int. Cl. F16M 13/02

(52) U.S. Cl. 248/223.41; 248/225.11; 248/224.8

(57) ABSTRACT

An apparatus is provided for attaching an accessory to a hanger holder for holding at least one hanger. The hanger holder has a frame and first and second hanger supports extending from spaced points on the frame. The apparatus includes a first arrangement having a top portion for receiving an end of the accessory, and a second arrangement, arranged adjacent and parallel to the first arrangement, for receiving a section of the frame of the hanger holder in a lengthwise opening. A device is provided for attaching an accessory to a hanger holder. The device includes a first receiving element adapted to receive a first end of the accessory, and a second receiving element arranged adjacent and parallel to the first receiving element and adapted to receive in a lengthwise opening a section of a frame of the hanger holder.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to hanger holders, and in particular relates to an accessory for a hanger holder.

2. Background of the Invention

Clothing hangers made of wood, plastic, metal or combinations thereof are in common use in the home. Empty hangers must be stored for use when needed. The empty hangers can be hung on the closet bar, along with those which are in use. However, storage of empty hangers in this way takes up limited closet space.

In order not to occupy hanging space, empty hangers could be stacked on a shelf in the closet or on the closet floor. However, hangers kept in such a manner tend to become tangled, making it difficult to extract a single hanger when needed. Hangers stored in this manner may also take up space needed for the storage of other things.

U.S. Pat. No. 5,924,578 relates to a hanger holder that includes first and second rods extend from spaced points on an open frame. The rods support a plurality of hangers situated in parallel planes. When the frame is mounted on a wall such that the rods extend horizontally, the hangers are retained on the rods by upwardly bent end sections. A third rod may be provided to engage the hanger near the point where the hook is attached. In one preferred embodiment, the upwardly bent end sections of the first and second rods are connected by an arcuate section and the third rod is joined to the arcuate section. A cover enclosing the hangers is employed in another preferred embodiment.

### BRIEF SUMMARY OF THE INVENTION

An apparatus is provided for attaching an accessory to a hanger holder for holding at least one hanger. The hanger holder has a frame and first and second hanger supports extending from spaced points on the frame. The apparatus includes a first arrangement having a top portion for receiving an end of the accessory, and a second arrangement, arranged adjacent and parallel to the first arrangement, for receiving a section of the frame of the hanger holder. The second arrangement includes a lengthwise opening adapted to receive the section of the frame.

The accessory may be a hook extending away from the frame. The first arrangement may define a first tubular space and the first end of the accessory may be substantially cylindrical. The second arrangement may define a second tubular space and the section of the frame of the hanger holder may be substantially cylindrical. A first diameter of the first end of the accessory may be substantially equal to a second diameter of the section of the hanger holder frame.

The frame may include a bend adjacent to the section of the frame. A further section of the frame opposite the bend from the section may be adapted to interact with a bottom portion of the apparatus to prevent movement of the apparatus after installation of the apparatus on the hanger holder. The bottom portion of the apparatus may be opposite the top end. The second arrangement may include a recess at the bottom portion, and the recess may be adapted to receive the further section of the frame.

The accessory may include a bend adjacent to the end, a portion of the accessory opposite the end from the bend being adapted to interact with the top end of the apparatus to prevent movement of the accessory after installation of the apparatus on the hanger holder. The first arrangement may include a recess at the top end, and the recess may be adapted to receive the portion of the accessory.

The opening may further allow removal of the section of the frame. The apparatus may be formed from one piece of an elastic material.

A device is provided for attaching an accessory to a hanger holder. The device includes a first receiving element adapted to receive a first end of the accessory, and a second receiving element arranged adjacent and parallel to the first receiving element. The second receiving element is adapted to receive in a lengthwise opening a section of a frame of the hanger holder.

The first receiving element may define a first tubular space and the first end of the accessory may be substantially cylindrical. The second receiving element may define a second tubular space and the section of the frame of the hanger holder may be substantially cylindrical. A first diameter of the first end of the accessory may be substantially equal to a second diameter of the section of the frame of the hanger holder.

The frame may include a bend adjacent to the section of the frame, and a further section of the frame opposite the bend from the section may be adapted to interact with a bottom end of the apparatus to prevent movement of the apparatus after installation of the apparatus on the hanger holder. The bottom end of the apparatus may be opposite the top end. The second receiving element may include a recess at the bottom end, and the recess may be adapted to receive the further section of the frame.

The accessory may include a bend adjacent to the end, and a portion of the accessory opposite the end from the bend may be adapted to interact with the top end of the apparatus to prevent movement of the accessory after installation of the apparatus on the hanger holder. The first receiving element may include a recess at the top end, and the recess may be adapted to receive the portion of the accessory.

The accessory may be a hook extending away from the wall, and the device may be formed from one piece of an elastic material.

A holder is provided for at least one hanger. The holder includes a base comprising frame rods, and first and second hanger support rods extend in a plane from spaced points on the base. The first and second rods are connected by an arcuate section. At least a portion of the arcuate section is inclined relative to the plane. The holder further includes an apparatus for attaching an accessory to the holder. The apparatus includes a first arrangement having a top end for receiving an end of the accessory, and a second arrangement arranged adjacent and parallel to the first arrangement. The second arrangement receives a section of the base of the hanger holder, and includes a lengthwise opening. The opening is adapted to receive the section of the base.

The holder may further include a third rod extending from the base to the arcuate section, and an arrangement for mounting the base on a vertical surface.

The holder may further include a device for attaching the holder to a door. The device may include a first arrangement for receiving a top edge of a door, the first arrangement may include first and second plates connected by a top plate. The first and second plates may be parallel to each other and perpendicular to the top plate. The first receiving arrangement may be adapted to receive a top edge of a door. The top edge of the door may abut the top plate. The device may further include a second arrangement for receiving a top section of the base. The second arrangement may include a hook opening upward and adapted to receive a portion of one of the frame rods.

These objects and the details of the invention will be apparent from the following description and accompanying drawings.

### BRIEF DESCRIPTION OF THE DRAWINGS

FIG. 1a is a perspective view of an accessory according to an exemplary embodiment of the present invention;

FIG. 1b is a bottom view of the accessory according to an exemplary embodiment shown in FIG. 1a;

FIG. 2 is a perspective view of a hanger hook according to an exemplary embodiment of the present invention;

FIG. 3 is a perspective view of a door bracket according to an exemplary embodiment of the present invention;

FIG. 4a is a perspective view of a hanger holder according to an exemplary embodiment of the present invention; and

FIG. 4b is a perspective view of a hanger holder including two accessories, two hanger hooks, and two door brackets according to an exemplary embodiment of the present invention.

### DETAILED DESCRIPTION OF THE INVENTION

The present invention relates to a device for the storage of clothing hangers and more particularly to a clothing hanger holder adapted to be mounted on a wall or shelf and which includes retaining means to prevent accidental dislodgement of the hangers. In particular, the present invention provides an apparatus for attaching an accessory to a hanger holder. The accessory may be a hook.

The device provided may be a nylon clip that holds a hook that may be used to hang anything a user wants, and in particular may be used for temporarily hanging clothes when doing laundry. The nylon clip connects to the hanger holder using an open slot and to the hanging hook with a closed tube section.

The hanging hook may be the same diameter as the hanger holder. A groove in one end of the closed tube section of the nylon clip may provide a stable orientation for the hanging hook with respect to the nylon clip.

The nylon clip may also stabilize the position of the hanger holder, for instance by a friction relationship with the door or wall to which the hanger holder is affixed.

The nylon clip's orientation with respect to the hanging holder may be stabilized by a groove or by the shape of the contact between the nylon clip and the door or wall to which the hanger holder is affixed. The contact between the device and a door may keep the hanging hook perpendicular to the door.

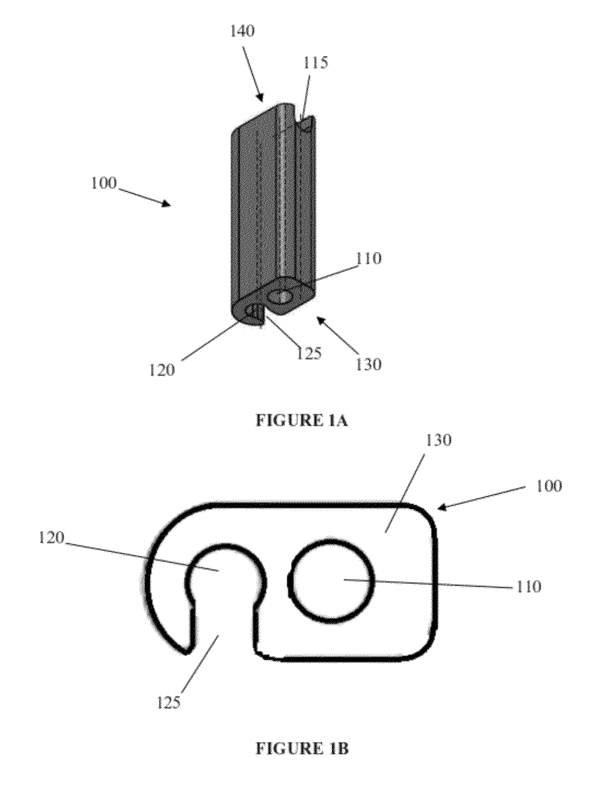

FIG. 1a is a perspective view of accessory 100. Accessory 100 defines first tubular space 110 and second tubular space 120. First tubular space 110 and second tubular space 120 may have substantially a same diameter. First tubular space 110 may extend from first end 130 of accessory 100 to second end 140 of accessory 100, and may be enclosed for substantially the entire length. Second end 140 may also be referred to herein as a top end of accessory 100, and first end 130 may also be referred to herein as a bottom end of accessory 100. First tubular space 110 may be adapted to receive an end of a hanger hook that may be inserted in second end 140 of first tubular space 110, and may include groove 115 on that end. In this manner, a hook attached to accessory 100 by first tubular space 110 may have a fixed orientation with respect to accessory 100 by the bend in the hook being received in groove 115.

Second tubular space 120 may extend from first end 130 of accessory 100 to second end 140 of accessory 100, and may include opening 125, which may extend along the entire length of second tubular space 120. Second tubular space 120 may be adapted to receive a portion of a frame of a hanger holder that may be inserted in opening 125. In this manner, accessory 100, and additionally perhaps a hook, may be attached to a hanger holder. The hook attached to accessory 100 may have a fixed orientation with respect to the hanger holder.

FIG. 1b is a bottom view of accessory 100 showing first end 130 of accessory 100. First tubular space 110 and second tubular space 120 may have openings on first end 130 that are substantially a same diameter. First tubular space 110 and second tubular space 120 may be substantially parallel along a length of accessory 100 extending from first end 130 to second end 140.

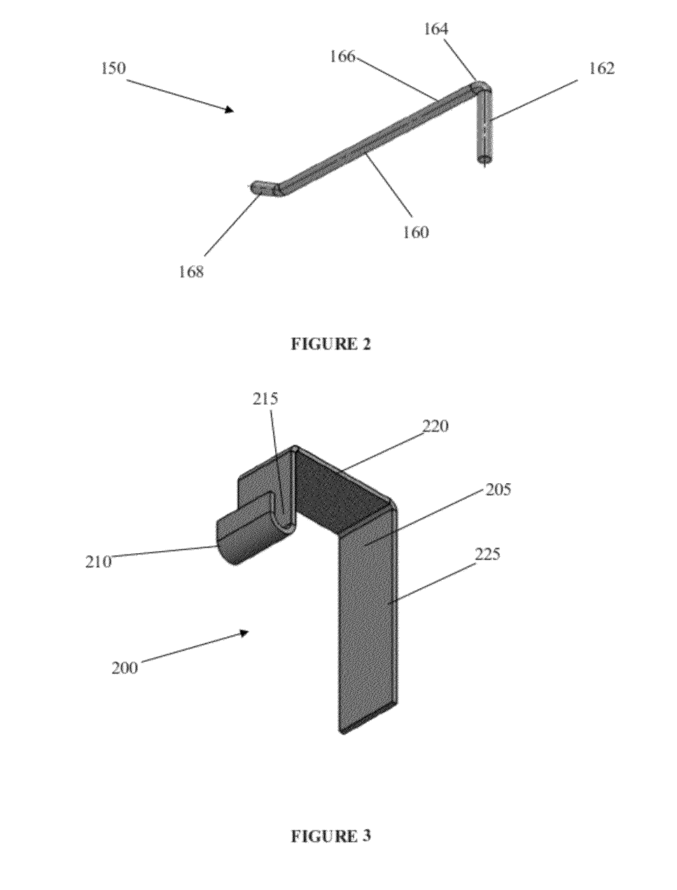

FIG. 2 is a perspective view of hanger hook 150. Hanger hook 150 may be made of plastic or metal, plastic covered metal, or any other appropriate material. In particular, hanger hook 150 may be made from a rod of metal (with or without a plastic outer layer) having a consistent diameter and bent into the shape of hanger hook 150. Hanger hook 150 may include central body 160 and upturned hook 168 on one end. On the opposite end of central body 160, hanger hook 150 may include section 162 that is adapted to be received in first tubular space 110 of accessory 100. Immediately adjacent to section 162 is bend 164 and then section 166. Bend 164 is adapted to be received in groove 115, and section 166 may rest on a portion of groove 115 to stabilize hanger hook 150 with respect to accessory 100.

FIG. 3 is a perspective view of door bracket 200. Door bracket 200 may be made of plastic or metal, plastic covered metal, or any other appropriate material. In particular, door bracket 200 may be made from a flat sheet of metal (with or without a plastic outer layer) having a consistent thickness and bent into the shape of door bracket 200. Door bracket 200 may include central body 205 and back plate 225 on one end. Adjacent to back plate 225, and separated from back plate 225 by a bend, is top door plate 220 of central body 205. Adjacent to top door plate 220, and separated from top door plate 220 by another bend, is hook 210 defining interior hook space 215. Interior hook space 215 is able to accommodate a portion of a frame of a hanger holder, and therefore has a diameter substantially equal to or greater than a diameter of the frame of a hanger holder. Door bracket 200 may therefore accommodate a frame of a hanger holder and attach a hanger holder to a door by placing door bracket 200 over a door such that top door plate 220 rests on top of the door, back plate 225 rests against one side of the door, and hook 210 rests against the other side of the door.

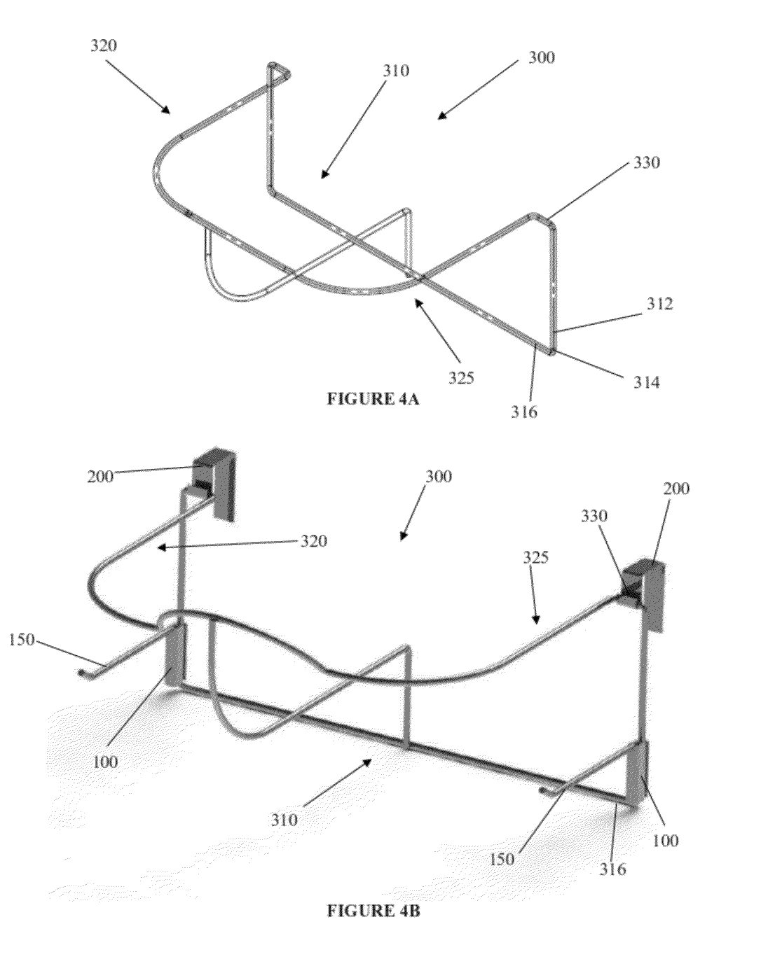

FIG. 4a is a perspective view of hanger holder 300. Hanger holder 300 may have a rod construction and may be manufactured from one or more rods being bent into a desired shape. Hanger holder 300 may be metal or plastic, metal coated with plastic, or any other appropriate material. Hanger holder 300 includes door stabilizing frame 310 and hanger holding frame 320. Door stabilizing frame 310 may form part or all of a rectangle or other trapezoid, or any other appropriate shape, and may be designed to rest substantially flat against a door surface. Hanger holding frame 320 may be designed to project out from a door surface when door stabilizing frame 310 is against a door surface, and may provide a structure that allows the storage of hangers. In particular, hanger holding frame 320 may include frame 325 adapted to receive a hanger or hangers for storage. Door stabilizing frame 310 may include bracket section 330 in an area of the top of door stabilizing frame 310, and adapted to be inserted in, or rest on, a door bracket, which in turn may rest on the top of a door to hold hanger holder 300. Door stabilizing frame 310 may also include lower frame bend 314 in an area of the bottom of door stabilizing frame 310. Lower frame bend 314 may connect vertical frame section 312 and horizontal frame section 316. Vertical frame section 312 may be adapted to receive an accessory holder, which may in turn be prevented from sliding downward by either lower frame bend 314 and/or horizontal frame section 316.

FIG. 4b is a perspective view of hanger holder 300 including two accessories 100 with corresponding hanger hooks 150, and two door brackets 200. Hanger holder 300 includes door stabilizing frame 310 and hanger holding frame 320. Hanger holding frame 320 may include frame 325 adapted to receive a hanger or hangers for storage. Door stabilizing frame 310 may include bracket section 330 in an area of the top of door stabilizing frame 310. Bracket section 330 may be adapted to be inserted in, or rest on, door bracket 200, which in turn may rest on the top of a door to hold hanger holder 300.

Door stabilizing frame 310 may also include horizontal frame section 316. A portion of door stabilizing frame may be adapted to receive accessory 100, which may in turn be prevented from sliding downward by horizontal frame section 316. Accessory 100 may hold hanger hook 150 in an orientation projecting out from the door and stabilized by a stable interaction between hanger hook 150 and accessory 100, and also by a stable interaction between accessory 100 and door stabilizing frame 310.

It should now be appreciated that the present invention provides an accessory item for a clothing hanger holder.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims.

1-21. (canceled)

22. In combination, a hanger holder comprising a frame, said frame comprising first and second upstanding frame members and an arcuate frame member extending between said first and second upstanding frame members adapted to support a hanger, an accessory adapted to be removably mounted to one of said upstanding frame members of said hanger holder, said accessory comprising a rod having first and second sections; and means for removably mounting said accessory to one of said upstanding frame members of said hanger holder, said mounting means comprising an end with a surface, a generally tubular recess and a generally tubular opening, said opening being adapted to engage said one upstanding frame member of said hanger holder such that said accessory mounting means end surface extends in a direction generally parallel to said arcuate member of said hanger holder, said recess being adapted to receive said first section of said rod such that said second section of said rod extends in a plane generally parallel to said accessory mounting means end surface.

23. The combination of claim 22 further comprising means for fixing the orientation of said rod relative to said accessory mounting means end surface.

24. The combination of claim 22 further comprising a groove in said accessory mounting means end surface adapted to receive at least a portion of said second section of said rod.

25. The combination of claim 22 wherein said rod further comprises a third section, wherein said third rod section is inclined relative to said second rod section.

26. The combination of claim 22 further comprising a bracket for mounting said hangar holder frame on a door.

27. The combination of claim 22 further comprising first and second brackets for mounting said hangar holder frame on a door.

28. The combination of claim 26 wherein said first upstanding frame member and said arcuate frame member are connected by a connecting frame member and wherein said bracket comprises means adapted to receive said connecting frame member.

29. The combination of claim 27 wherein each of said first and second upstanding frame members are connected to said arcuate frame member by a different connecting frame member and wherein each of said first and second brackets comprises means adapted to receive a different one of said connecting frame members.

30. In combination, a hanger holder comprising a frame, said frame comprising first and second upstanding frame members and an arcuate frame member extending between said first and second upstanding frame members and adapted to support a hanger; and a first bracket for mounting said frame on a door, said frame comprising a first member connecting said first upstanding frame member and said arcuate frame member, wherein said bracket comprises first means for supporting said first connecting frame member.

31. The combination of claim 30 further comprising a second bracket for mounting said frame on a door, said frame comprising a second frame member connecting said second upstanding frame member and said arcuate frame member, wherein said second bracket comprises second means for supporting said second connecting frame member.

32. The combination of claim 30 wherein said first supporting means comprises a hook.

33. The combination of claim 32 wherein said hook has a generally “U” shape.

34. The combination of claim 30 further comprising an accessory and means for mounting said accessory to said first upstanding frame member.

35. The combination of claim 34 wherein said accessory mounting means comprises means for engaging said first upstanding member, and means for receiving said accessory.

36. The combination of claim 34 wherein said accessory mounting means comprises means for fixing the orientation of said accessory relative to said first upstanding member.

37. In combination, a hanger holder comprising a frame, said frame comprising first and second upstanding frame members and a frame member extending in a plane between said first and second upstanding frame members adapted to support a hanger, an accessory adapted to be removably mounted to one of said upstanding frame members of said hanger holder, said accessory comprising a rod having first and second sections; and means for removably mounting said accessory to one of said upstanding frame members of said hanger holder, said mounting means comprising an end with a surface, a generally tubular recess and a generally tubular opening, said opening being adapted to engage said one upstanding frame member of said hanger holder such that said accessory mounting means end surface extends in a direction generally parallel to said plane of said extending frame member of said hanger holder, said recess being adapted to receive said first section of said rod such that said second section of said rod extends in a plane generally parallel to said accessory mounting means end surface.
